(19) United States
(12) Patent Application Publication
(10) Pub. No.: US 2015/0271783 A1
(43) Pub. Date: Sep. 24, 2015

(54) PAGING METHOD AND DEVICE

(71) Applicant: Huawei Technologies Co., Ltd., Shenzhen (CN)

(72) Inventors: Zhenxing Hu, Beijing (CN); Wei Quan, Beijing (CN); Jian Zhang, Beijing (CN)

(21) Appl. No.: 14/733,535

(22) Filed: Jun. 8, 2015

Related U.S. Application Data
(63) Continuation of application No. PCT/CN2012/086028, filed on Dec. 6, 2012.

(51) Int. Cl. H04W 68/02; H04W 72/04; H04W 52/02

(52) U.S. Cl. CPC H04W 68/02; H04W 52/0206; H04W 72/042

(57) ABSTRACT

The present invention provides a paging method and device. The method includes: obtaining, by a core network element, cell type information supported by a terminal; and sending, by the core network element, a paging message to a base station, where the paging message carries the cell type information supported by the terminal or a cell identity determined according to the cell type information supported by the terminal, so that the base station sends a paging message to a cell corresponding to the cell type information supported by the terminal or a cell corresponding to the cell identity. Embodiments of the present invention can reduce system energy overheads.

### CROSS-REFERENCE TO RELATED APPLICATIONS

This application is a continuation of International Application No. PCT/CN2012/086028, filed on Dec. 6, 2012, which is hereby incorporated by reference in its entirety.

### TECHNICAL FIELD

The present invention relates to communications technologies, and in particular, to a paging method and device.

### BACKGROUND

In a communications system, when a terminal (also referred to as a user equipment, UE) is in an idle state, if downlink data arrives at a network side, the network side looks for the UE in a manner of paging. A core network element sends a paging message to all base stations connected to the core network element, and the base stations send the paging message to all cells included in the base stations. For example, in a long term evolution (LTE) communications system, a mobility management entity (MME) sends a paging message to all evolved base stations (evolved NodeB, eNB) connected to the MME, and the eNBs send the paging message to all cells included in the eNBs.

A new carrier type (NCT) cell is an extended cell, and can independently complete signaling exchange with a UE, without a need for help by a macro cell. Meanwhile, the NCT cell may be a discretely distributed cell, which means, provides a service only in a hotspot area within a range. Within this range, if a UE is located in the hotspot area that can be covered by the NCT cell, the UE can access the NCT cell and be served; if a UE is located in a non-hotspot area that cannot be covered by the NCT cell, the UE can access a conventional macro cell to obtain a service. To achieve an objective of saving energy for a network, the NCT cell may be activated or put to sleep by means of control.

However, some UEs do not support the NCT cell. Therefore, for this type of UE, a paging message sent by a base station to the NCT cell has no actual meaning, which wastes energy of the network and the UEs.

### SUMMARY

In view of this, embodiments of the present invention provide a paging method and device, which are used to solve a problem of energy wasting that exists in the prior art.

According to a first aspect, a paging method is provided, and includes:

obtaining, by a core network element, cell type information supported by a terminal; and

sending, by the core network element, a paging message to a base station, where the paging message carries the cell type information supported by the terminal or a cell identity determined according to the cell type information supported by the terminal, so that the base station sends a paging message to a cell corresponding to the cell type information supported by the terminal or a cell corresponding to the cell identity.

With reference to the first aspect, in a first possible implementation manner of the first aspect, the method further includes:

receiving, by the core network element, cell configuration information of the base station that is sent by the base station, where the cell configuration information of the base station includes cell type information supported by the base station, where

the sending, by the core network element, a paging message to a base station includes:

sending the paging message to the base station when the core network element determines, according to the cell configuration information of the base station and the cell type information supported by the terminal, that the base station has a first cell, where a type of the first cell is a cell type supported by the terminal.

With reference to the first possible implementation manner of the first aspect, in a second possible implementation manner of the first aspect, the paging message carries an intersection set of the cell type information supported by the terminal and the cell type information supported by the base station.

With reference to the first aspect, in a third possible implementation manner of the first aspect, the method further includes:

receiving, by the core network element, cell configuration information of the base station that is sent by the base station, where the cell configuration information of the base station includes cell type information supported by the base station, and a cell identity and activation/sleep switching pattern information core network element of each cell of the base station, where

the sending, by the core network element, a paging message to a base station includes:

sending the paging message to the base station when the core network element determines, according to the cell configuration information of the base station and the cell type information supported by the terminal, that the base station has a first cell in an active state, where a type of the first cell is a cell type supported by the terminal.

With reference to the third possible implementation manner of the first aspect, in a fourth possible implementation manner of the first aspect, the paging message carries a cell identity of the first cell.

With reference to the first aspect or the first to fourth possible implementation manners of the first aspect, in a fifth possible implementation manner of the first aspect, the cell type information supported by the terminal is a cell type supported by the terminal, and the obtaining, by a core network element, cell type information supported by a terminal includes:

when the core network element receives a downlink data notification message, obtaining, by the core network element, context information of the terminal according to an evolved packet system (EPS) bearer identity or a terminal identifier carried in the downlink data notification message; and

obtaining the cell type supported by the terminal from the context information of the terminal.

With reference to the first aspect or the first to fourth possible implementation manners of the first aspect, in a sixth possible implementation manner of the first aspect, the cell type information supported by the terminal is a cell type supported by the terminal, and the obtaining, by a core network element, cell type information supported by a terminal includes:

when the core network element receives a downlink data notification message, obtaining context information of the terminal according to an EPS bearer identity or a terminal identifier carried in the downlink data notification message;

obtaining an index of cell type support capability information of the terminal from the context information of the terminal; and

determining, according to the index of cell type support capability information of the terminal and a preconfigured first correspondence, the cell type supported by the terminal, where the first correspondence is a correspondence between the cell type supported by the terminal and the index of cell type support capability information of the terminal.

With reference to the first aspect or the first to fourth possible implementation manners of the first aspect, in a seventh possible implementation manner of the first aspect, the cell type information supported by the terminal is an index of cell type support capability information of the terminal, and the obtaining, by a core network element, cell type information supported by a terminal includes:

when the core network element receives a downlink data notification message, obtaining context information of the terminal according to an EPS bearer identity or a terminal identifier carried in the downlink data notification message; and

obtaining the index of cell type support capability information of the terminal from the context information of the terminal.

With reference to the first aspect, the first possible implementation manner of the first aspect, and the fifth to seventh possible implementation manners of the first aspect, in an eighth possible implementation manner of the first aspect, the paging message carries the cell identity determined according to the cell type information supported by the terminal, and after the obtaining, by a core network element, cell type information supported by a terminal, the method further includes:

determining the cell identity according to the cell type information supported by the terminal and a second correspondence, where the second correspondence is a correspondence between the cell type information supported by the terminal and the cell identity, and the second correspondence is reported by the base station or locally configured in the core network element.

With reference to the first aspect or the first to eighth possible implementation manners of the first aspect, in a ninth possible implementation manner of the first aspect, the method further includes:

receiving, by the core network element, capability information reported by the terminal, or obtaining capability information of the terminal from a home subscriber server (HSS), where the capability information includes the cell type information supported by the terminal.

According to a second aspect, a paging method is provided, and includes:

receiving, by a base station, a paging message sent by a core network element, where the paging message carries cell type information supported by a terminal or a cell identity determined according to cell type information supported by a terminal; and

sending, by the base station, a paging message to a cell corresponding to the cell type information supported by the terminal or the cell identity.

With reference to the second aspect, in a first possible implementation manner of the second aspect, the method further includes:

sending, by the base station, cell configuration information of the base station to the core network element, where the cell configuration information of the base station includes cell type information supported by the base station, so that the core network element sends the paging message to the base station when determining, according to the cell configuration information of the base station and the cell type information supported by the terminal, that the base station has a first cell, where a type of the first cell is a cell type supported by the terminal.

With reference to the second aspect, in a second possible implementation manner of the second aspect, the method further includes:

sending, by the base station, cell configuration information of the base station to the core network element, where the cell configuration information of the base station includes cell type information supported by the base station, and a cell identity and activation/sleep switching pattern information of each cell of the base station, so that the core network element sends the paging message to the base station when determining, according to the cell configuration information of the base station and the cell type information supported by the terminal, that the base station has a first cell in an active state, where a type of the first cell is a cell type supported by the terminal.

With reference to the second possible implementation manner of the second aspect, in a third possible implementation manner of the second aspect, the paging message carries a cell identity of the first cell.

With reference to the second aspect or the first or second possible implementation manner of the second aspect, in a fourth possible implementation manner of the second aspect, the paging message carries the cell type information supported by the terminal, the cell type information supported by the terminal is an index of cell type support capability information of the terminal, and the sending, by the base station, a paging message to a cell corresponding to the cell type information supported by the terminal includes: determining, according to the index of cell type support capability information of the terminal and a preconfigured first correspondence, the cell type supported by the terminal, and sending the paging message to a cell corresponding to the cell type supported by the terminal, where the first correspondence is a correspondence between the cell type supported by the terminal and the index of cell type support capability information of the terminal.

With reference to the second aspect or the first to fourth possible implementation manners of the second aspect, in a fifth possible implementation manner of the second aspect, the method further includes:

collecting, by the base station, statistics on a first quantity and a second quantity within a set duration, where the first quantity is a quantity of paging messages that arrive when a new carrier type (NCT) cell is in an active state, and the second quantity is a quantity of paging messages that arrive when the NCT cell is in a sleep state;

determining, by the base station, whether the first quantity and the second quantity match current activation/sleep switching pattern information of the NCT cell; and

when the first quantity and the second quantity do not match the current activation/sleep switching pattern information of the NCT cell, adjusting, by the base station, the activation/sleep switching pattern information of the NCT cell, so that adjusted activation/sleep switching pattern information matches the first quantity and the second quantity.

According to a third aspect, a paging method is provided, and includes:

obtaining, by a terminal, cell type support capability information of the terminal; and

sending, by the terminal, the cell type support capability information of the terminal to a core network element, so that the core network element obtains and stores, according to the cell type support capability information of the terminal, cell type information supported by the terminal, and when the core network element sends a paging message to a base station, the paging message carries the cell type information supported by the terminal or a cell identity determined according to the cell type information supported by the terminal.

According to a fourth aspect, a paging device is provided, and includes:

an obtaining module, configured to obtain cell type information supported by a terminal; and

a sending module, configured to send a paging message to a base station, where the paging message carries the cell type information supported by the terminal or a cell identity determined according to the cell type information supported by the terminal, so that the base station sends a paging message to a cell corresponding to the cell type information supported by the terminal or a cell corresponding to the cell identity.

With reference to the fourth aspect, in a first possible implementation manner of the fourth aspect, the device further includes:

a receiving module, configured to receive cell configuration information of the base station that is sent by the base station, where the cell configuration information of the base station includes cell type information supported by the base station, where

the sending module is specifically configured to send the paging message to the base station when it is determined, according to the cell configuration information of the base station and the cell type information supported by the terminal, that the base station has a first cell, where a type of the first cell is a cell type supported by the terminal.

With reference to the first possible implementation manner of the fourth aspect, in a second possible implementation manner of the fourth aspect, the paging message sent by the sending module carries an intersection set of the cell type information supported by the terminal and the cell type information supported by the base station.

With reference to the fourth aspect, in a third possible implementation manner of the fourth aspect, the device further includes:

a receiving module, configured to receive cell configuration information of the base station that is sent by the base station, where the cell configuration information of the base station includes cell type information supported by the base station, and a cell identity and activation/sleep switching pattern information of each cell of the base station, where

the sending module is specifically configured to send the paging message to the base station when it is determined, according to the cell configuration information of the base station and the cell type information supported by the terminal, that the base station has a first cell in an active state, where a type of the first cell is a cell type supported by the terminal.

With reference to the third possible implementation manner of the fourth aspect, in a fourth possible implementation manner of the fourth aspect, the paging message sent by the sending module carries a cell identity of the first cell.

With reference to the fourth aspect or any one of the first to fourth possible implementation manners of the fourth aspect, in a fifth possible implementation manner of the fourth aspect, wherein the cell type information supported by the terminal is the cell type supported by the terminal, and the obtaining module is specifically configured to: when a downlink data notification message is received, obtain context information of the terminal according to an evolved packet system (EPS) bear identity or a terminal identifier carried in the downlink data notification message; and obtain the cell type supported by the terminal from the context information of the terminal.

With reference to the fourth aspect or any one of the first to fourth possible implementation manners of the fourth aspect, in a sixth possible implementation manner of the fourth aspect, the cell type information supported by the terminal is the cell type supported by the terminal, and the obtaining module is specifically configured to:

when a core network element receives a downlink data notification message, obtain context information of the terminal according to an EPS bearer identity or a terminal identifier carried in the downlink data notification message;

obtain an index of cell type support capability information of the terminal from the context information of the terminal; and

determine, according to the index of cell type support capability information of the terminal and a preconfigured first correspondence, the cell type supported by the terminal, where the first correspondence is a correspondence between the cell type supported by the terminal and the index of cell type support capability information of the terminal.

With reference to the fourth aspect or any one of the first to fourth possible implementation manners of the fourth aspect, in a seventh possible implementation manner of the fourth aspect, the cell type information supported by the terminal is an index of cell type support capability information of the terminal, and the obtaining module is specifically configured to:

when a core network element receives a downlink data notification message, obtain context information of the terminal according to an EPS bearer identity or a terminal identifier carried in the downlink data notification message; and

obtain the index of cell type support capability information of the terminal from the context information of the terminal.

With reference to the fourth aspect, the first possible implementation manner of the fourth aspect or any one of the fifth to seventh possible implementation manners of the fourth aspect, in an eighth possible implementation manner of the fourth aspect, the paging message carries the cell identity determined according to the cell type information supported by the terminal, and the device further includes:

a determining module, configured to determine the cell identity according to the cell type information supported by the terminal and a second correspondence, where the second correspondence is a correspondence between the cell type information supported by the terminal and the cell identity, and the second correspondence is reported by the base station or locally configured in the paging device.

With reference to the fourth aspect or the first to eighth possible implementation manners of the fourth aspect, in a ninth possible implementation manner of the fourth aspect, the device further includes:

a capability obtaining module, configured to receive capability information reported by the terminal, or obtain capability information of the terminal from a home subscriber server (HSS), where the capability information includes the cell type information supported by the terminal.

According to a fifth aspect, a paging device is provided, and includes:

a receiving module, configured to receive a paging message sent by a core network element, where the paging message carries cell type information supported by a terminal or a cell identity determined according to cell type information supported by a terminal; and

a processing module, configured to send a paging message to a cell corresponding to the cell type information supported by the terminal or the cell identity.

With reference to the fifth aspect, in a first possible implementation manner of the fifth aspect, the device further includes:

a sending module, configured to send cell configuration information of a base station to the core network element, where the cell configuration information of the base station includes cell type information supported by the base station, so that the core network element sends the paging message to the base station when determining, according to the cell configuration information of the base station and the cell type information supported by the terminal, that the base station has a first cell, where a type of the first cell is a cell type supported by the terminal.

With reference to the fifth aspect, in a second possible implementation manner of the fifth aspect, the device further includes:

a sending module, configured to send cell configuration information of a base station to the core network element, where the cell configuration information of the base station includes cell type information supported by the base station, and a cell identity and activation/sleep switching pattern information of each cell of the base station, so that the core network element sends the paging message to the base station when determining, according to the cell configuration information of the base station and the cell type information supported by the terminal, that the base station has a first cell in an active state, where a type of the first cell is a cell type supported by the terminal.

With reference to the second possible implementation manner of the fifth aspect, in a third possible implementation manner of the fifth aspect, the paging message received by the receiving module carries a cell identity of the first cell.

With reference to the fifth aspect or the first or second possible implementation manner of the fifth aspect, in a fourth possible implementation manner of the fifth aspect, the paging message carries the cell type information supported by the terminal, the cell type information supported by the terminal is an index of cell type support capability information of the terminal, and the processing module is specifically configured to:

determine, according to the index of cell type support capability information of the terminal and a preconfigured first correspondence, the cell type supported by the terminal, and send the paging message to a cell corresponding to the cell type supported by the terminal, where the first correspondence is a correspondence between the cell type supported by the terminal and the index of cell type support capability information of the terminal.

With reference to the fifth aspect or the first to fourth possible implementation manners of the fifth aspect, in a fifth possible implementation manner of the fifth aspect, the device further includes:

a statistics module, configured to collect statistics on a first quantity and a second quantity within a set duration, where the first quantity is a quantity of paging messages that arrive when a new carrier type (NCT) cell is in an active state, and the second quantity is a quantity of paging messages that arrive when the NCT cell is in a sleep state;

a determining module, configured to determine whether the first quantity and the second quantity match current activation/sleep switching pattern information of the NCT cell; and

an adjusting module, configured to: when the first quantity and the second quantity do not match the current activation/sleep switching pattern information of the NCT cell, adjust the activation/sleep switching pattern information of the NCT cell, so that adjusted activation/sleep switching pattern information matches the first quantity and the second quantity.

According to a sixth aspect, a paging device is provided, and includes:

an obtaining module, configured to obtain cell type support capability information of the paging device; and

a sending module, configured to send the cell type support capability information of a terminal to a core network element, so that the core network element obtains and stores, according to the cell type support capability information of the terminal, cell type information supported by the terminal, and when the core network element sends a paging message to a base station, the paging message carries the cell type information supported by the terminal or a cell identity determined according to the cell type information supported by the terminal.

According to a seventh aspect, a core network device is provided, and includes a transmitter, a receiver, a memory, and a processor that is separately connected to the transmitter, the receiver, and the memory, where a group of program code is stored in the memory, and the processor is configured to invoke the program code stored in the memory to perform the steps according to any method in the first aspect.

According to an eighth aspect, an access network device is provided, and includes a transmitter, a receiver, a memory, and a processor that is separately connected to the transmitter, the receiver, and the memory, where a group of program code is stored in the memory, and the processor is configured to invoke the program code stored in the memory to perform the steps according to any method in the second aspect.

According to a ninth aspect, a terminal is provided, and includes a transmitter, a receiver, a memory, and a processor that is separately connected to the transmitter, the receiver, and the memory, where a group of program code is stored in the memory, and the processor is configured to invoke the program code stored in the memory to perform the steps according to the third aspect.

According to a tenth aspect, a computer program product is provided, and includes a computer-readable medium, where the computer-readable medium includes a group of program code that is used to perform the steps according to any item in the first aspect.

According to an eleventh aspect, a computer program product is provided, and includes a computer-readable medium, where the computer-readable medium includes a group of program code that is used to perform the steps according to any item in the second aspect.

According to a twelfth aspect, a computer program product is provided, and includes a computer-readable medium, where the computer-readable medium includes a group of program code that is used to perform the steps according to the third aspect.

By using the foregoing technical solutions, a paging message sent by a core network element to a base station carries cell type information supported by a terminal or a cell identity determined according to cell type information supported by a terminal; the base station sends a paging message to a cell corresponding to the cell type information supported by the terminal or a cell corresponding to the cell identity determined according to the cell type information supported by the terminal instead of sending the paging message to all cells included in the base station. This can reduce a quantity of sent paging messages, and reduce system energy overheads.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a schematic flowchart of an embodiment of a paging method according to the present invention;

FIG. 2a is a schematic flowchart of another embodiment of a paging method according to the present invention;

FIG. 2b is a schematic flowchart of another embodiment of a paging method according to the present invention;

FIG. 2c is a schematic flowchart of reporting cell type support capability information according to an embodiment of the present invention;

FIG. 3 is a schematic flowchart of another embodiment of a paging method according to the present invention;

FIG. 4 is a schematic flowchart of another embodiment of a paging method according to the present invention;

FIG. 5 is a schematic flowchart of another embodiment of a paging method according to the present invention;

FIG. 6 is a schematic flowchart of another embodiment of a paging method according to the present invention;

FIG. 7a is a schematic structural diagram of an embodiment of a paging device according to the present invention;

FIG. 7b is a schematic structural diagram of an embodiment of a core network element according to the present invention;

FIG. 8a is a schematic structural diagram of another embodiment of a paging device according to the present invention;

FIG. 8b is a schematic structural diagram of an embodiment of an access network element according to the present invention;

FIG. 9a is a schematic structural diagram of another embodiment of a paging device according to the present invention;

FIG. 9b is a schematic structural diagram of another embodiment of an access network element according to the present invention;

FIG. 10a is a schematic structural diagram of another embodiment of a paging device according to the present invention; and

FIG. 10b is a schematic structural diagram of an embodiment of a terminal according to the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

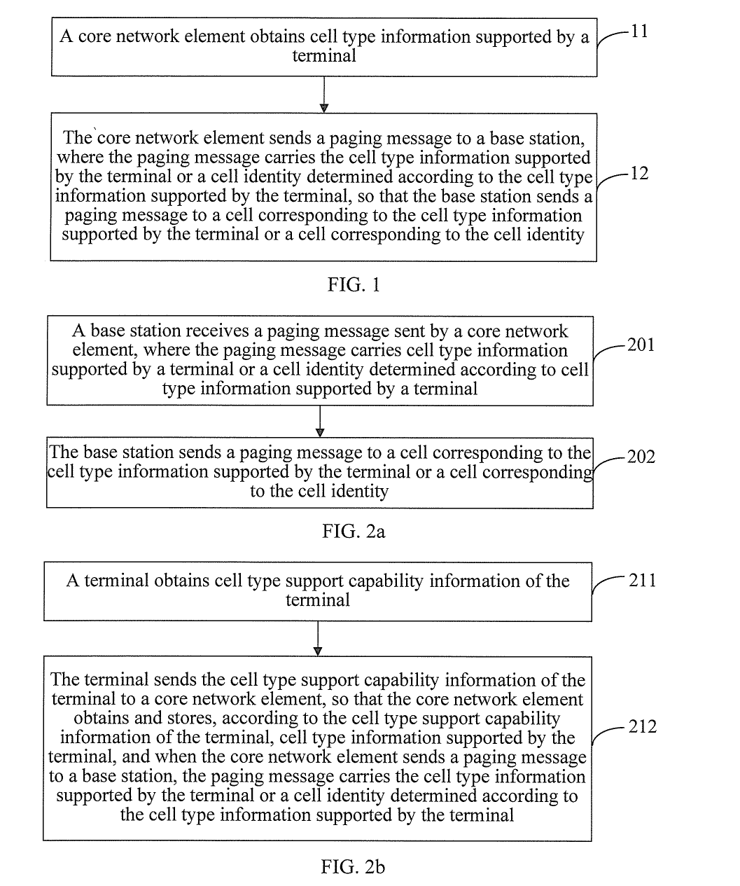

FIG. 1 is a schematic flowchart of an embodiment of a paging method according to the present invention, and the paging method includes:

11: A core network element obtains cell type information supported by a terminal.

12: The core network element sends a paging message to abase station, where the paging message carries the cell type information supported by the terminal or a cell identity determined according to the cell type information supported by the terminal, so that the base station sends a paging message to a cell corresponding to the cell type information supported by the terminal or a cell corresponding to the cell identity.

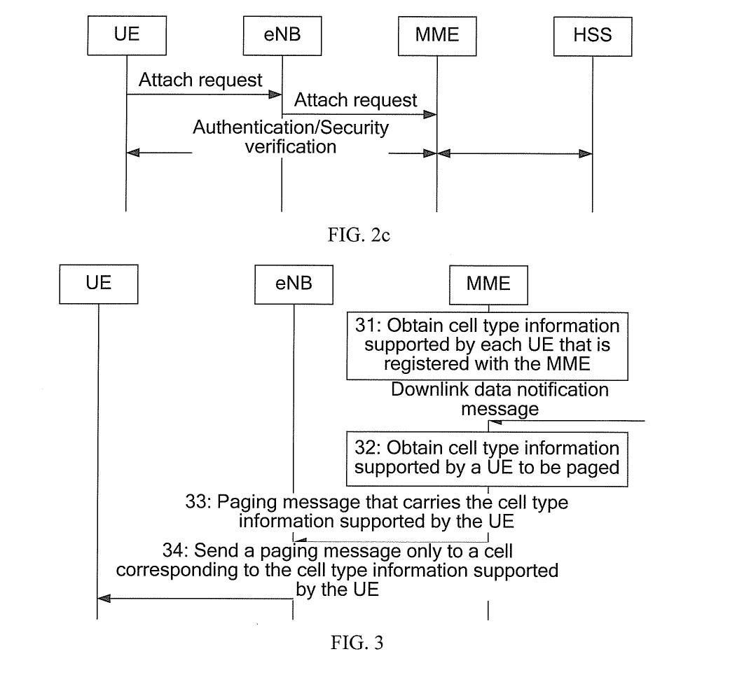

Accordingly, referring to FIG. 2a, a process executed by a base station includes:

201: The base station receives a paging message sent by a core network element, where the paging message carries cell type information supported by a terminal or a cell identity determined according to cell type information supported by a terminal.

202: The base station sends a paging message to a cell corresponding to the cell type information supported by the terminal or a cell corresponding to the cell identity.

Referring FIG. 2b, a process executed by a terminal includes:

211: The terminal obtains cell type support capability information of the terminal.

212: The terminal sends the cell type support capability information of the terminal to a core network element, so that the core network element obtains and stores, according to the cell type support capability information of the terminal, cell type information supported by the terminal, and when the core network element sends a paging message to a base station, the paging message carries the cell type information supported by the terminal or a cell identity determined according to the cell type information supported by the terminal.

For example, as shown in FIG. 2c, a UE may send, in an attach request, cell type support capability information of a terminal to a base station (for example, an eNB), and then the base station sends the cell type support capability information to a core network element (for example, an MME). In a process of authentication and security verification (authentication/security), the core network element may store the cell type support capability information of the terminal in context information of the corresponding terminal.

Alternatively, the UE may add the cell type support capability information of the terminal to a radio resource control (RRC) message so that the RRC message carries the cell type support capability information of the terminal to the base station, and then the base station informs the core network network element of the cell type support capability information. The RRC message, for example, may be an RRC connection setup complete message, an RRC connection reconfiguration (RRC connection reconfiguration complete) message, or the like.

For different systems, the core network element, the base station, and the terminal have different names, and for example, may be the MME, the eNB, and the UE respectively, or be a serving general packet radio service support node (SGSN), a radio network controller (RNC), and the UE respectively, or be an SGSN, a base transceiver station (BTS), and a mobile station (MS) respectively.

In this embodiment of the present invention, an LTE system is used as an example, that is, the core network element, the base station, and the terminal are the MME, the eNB, and the UE respectively.

In this embodiment of the present invention, the cell type information supported by the terminal may specifically be a cell type supported by the terminal, for example, a type 1, a type 2, a type 3 . . . , or be an index of cell type support capability information of the terminal, for example, an index of a cell type A and an index of a cell type B, for example, 1, 2 . . . , or be frequency band information of a cell type A and frequency band information of a cell type B. The core network element may obtain the cell type information supported by the terminal from the context information of the terminal; or the core network element obtains one type of information from the context information of the terminal, and then obtains another type of information according to a correspondence between specific content and an index, where the one type of information and the another type of information are the cell type supported by the terminal and the index of cell type support capability information of the terminal respectively. Alternatively, the core network element obtains the cell type information supported by the terminal from the context information of the terminal, and then obtains a cell identity according to a correspondence between the obtained cell type information and the cell identity.

The cell corresponding to the cell type information supported by the terminal or the cell corresponding to the cell identity may be referred to as a first cell, and there may be one or more first cells.

In this embodiment, a paging message sent by a core network element to a base station carries cell type information supported by a terminal or a cell identity determined according to cell type information supported by a terminal; when sending a paging message, the base station sends the paging message to a cell corresponding to the cell type information supported by the terminal or a cell corresponding to the cell identity determined according to the cell type information supported by the terminal instead of sending the paging message to all cells included in the base station. This can reduce a quantity of sent paging messages, and reduce system energy overheads.

FIG. 3 is a schematic flowchart of another embodiment of a paging method according to the present invention, and in this embodiment, a paging message sent by an MME to an eNB carries cell type information supported by a UE. This embodiment includes:

31: The MME obtains cell type information supported by each UE that is registered with the MME.

After a UE is powered on, the UE may be registered with the MME by using an attach process, and in this process, the UE reports capability information of the UE to the MME. Alternatively, the MME may also obtain capability information of the UE from a home subscriber server (HSS). The capability information of the UE may carry the cell type information supported by the UE.

The MME may store an identifier of the UE and context information of the UE in a correspondence manner, and the context information of the UE may store the cell type information supported by the corresponding UE.

The cell type information supported by the UE in this embodiment may be specific content of a cell type, for example a type 1, a type 2 . . . , where the type 1 may specifically be a new type of cell, for example, an NCT cell, and the type 2 may specifically be a conventional type of cell.

The cell type information supported by the UE in this embodiment may also be an index of cell type support capability information of a terminal, for example, 1 and 2, where 1 may indicate a new type of cell, and 2 indicates a conventional type of cell, or be information about a frequency band in which the cell type is located.

32: After receiving a downlink data notification message, the MME obtains cell type information supported by a UE to be paged.

It may be that the downlink data notification message carries an evolved packet system (EPS) bearer ID, or carries a UE identifier, and the MME may determine, according to the EPS bearer ID or the UE identifier, context information of the UE to be paged, and find the cell type information supported by the UE from the context information. In this case, a representation manner of a cell type obtained by the MME is consistent with a representation manner of a cell type reported by the UE. For example, if what the UE reports is a cell type supported by the UE, what the MME obtains is also a cell type supported by the UE, and later what the MME adds to the paging message is also the cell type supported by the UE.

Alternatively, it may also be that the downlink data notification message carries an EPS bearer ID or a UE identifier, and the MME may determine, according to the EPS bearer ID or the UE identifier, context information of the UE to be paged, and find the cell type information supported by the UE from the context information. In addition, a correspondence between one type of information and another type of information, which are about a cell type, is further preconfigured in the MME, and a representation manner of a cell type finally obtained by the MME is inconsistent with a representation manner of a cell type reported by the UE. For example, if what the UE reports is a cell type supported by the UE, what the MME obtains from the context of the UE is also a cell type supported by the UE, later the MME may obtain an index of cell type support capability information of the UE according to a preconfigured correspondence between the cell type and the index of cell type support capability information of the terminal, and later what the paging message carries is also the index of cell type support capability information of the UE.

33: The MME sends a paging message to the eNB, where the paging message carries the cell type information supported by the UE.

34: The eNB sends a paging message only to a cell corresponding to the cell type information supported by the UE.

For example, cells that the eNB serves include a cell 1, a cell 2, and a cell 3, and a type of the cell 1 is a type 1, a type of the cell 2 is a type 2, and a type of the cell 3 is a type 3. A correspondence between a cell identity and a cell type of the cell that the eNB serves may be configured during planning.

If the paging message sent by the MME carries the type 1 and the type 2, the eNB may send the paging message only in the cell 1 and the cell 2, but does not send the paging message in the cell 3.

Optionally, it may be that preconfigured cell type information corresponding to a cell identity in the eNB is consistent with received cell type information, and in this case, a corresponding cell may be determined directly according to the correspondence. For example, a preconfigured correspondence in the eNB may be a correspondence between a cell type and a cell identity. In this case, when information received by the eNB is the cell type supported by the UE, such as the type 1 and the type 2, a corresponding cell may be determined directly according to the correspondence, and the paging message is sent only to the corresponding cell.

Alternatively, it may also be that preconfigured cell type information corresponding to a cell identity in the eNB is inconsistent with received cell type information. In this case, in addition to a correspondence between a cell identity and one type of cell type information, a correspondence between the one type of cell type information and another type of cell type information needs to be further configured in the eNB. For example, a correspondence between a cell type and a cell identity is configured, and a correspondence between the cell type and an index of cell type support capability information is configured in the eNB, and the paging message received by the eNB carries the index of cell type support capability information. Then a corresponding cell may be determined according to the index and the two correspondences, and the paging message is sent only to the corresponding cell.

In this embodiment, a paging message sent by an MME to an eNB carries cell type information supported by a UE, so that the eNB may send a paging message only to a cell corresponding to the cell type information supported by the UE, which reduces system energy overheads.

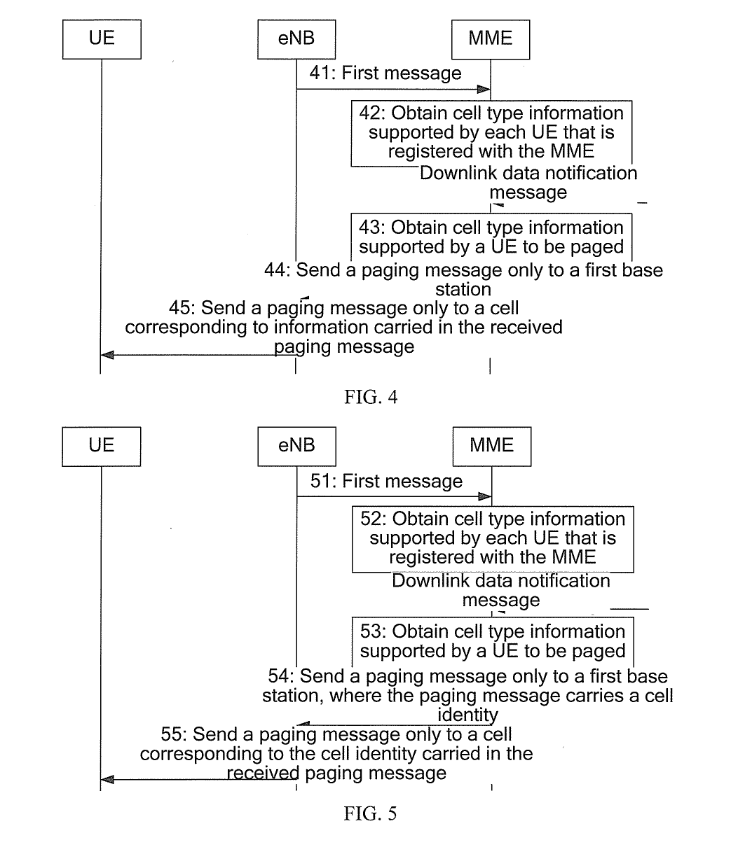

FIG. 4 is a schematic flowchart of another embodiment of a paging method according to the present invention, and in this embodiment, an eNB sends a message to an MME, so that the MME sends a paging message to a specific eNB instead of sending the paging message to all eNBs connected to the MME. This embodiment includes:

41: Each eNB connected to the MME sends a first message to the MME, where the first message carries cell configuration information of the eNB, and the cell configuration information is cell type information supported by the eNB.

The first message may be an existing message, or be a newly added message.

The existing message, for example, is a setup request (S1 SETUP REQUEST) message, and in this case, the MME may further send a setup response (S1 SETUP RESPONSE) message to the eNB; or is a configuration update (ENB CONFIGURATION UPDATE) message, and in this case, the MME may further send a configuration update response (ENB CONFIGURATION UPDATE ACKNOWLEDGE) message to the eNB.

After receiving the first message sent by the eNB, the MME may store the cell type information supported by the eNB. A specific representation manner of the cell type information supported by the eNB may be a cell type supported by the eNB, for example, a type 1, a type 2 . . . , or may be an index of cell type support capability information supported by the eNB, for example, 1, 2 . . . , or information about a frequency band in which the cell type is located.

42: The MME obtains cell type information supported by each UE that is registered with the MME.

43: After receiving a downlink data notification message, the MME obtains cell type information supported by a UE to be paged.

Reference may be made to 31 to 32 for specific content of 42 to 43.

44: The MME determines a first eNB, and sends a paging message only to the first eNB, where the paging message carries the cell type information supported by the UE or an intersection set of cell type information supported by the first eNB and the cell type information supported by the UE, and the first eNB refers to an eNB, where an intersection set exists between cell type information supported by the eNB and the cell type information supported by the UE.

For example, when it is determined, according to the cell type information supported by the eNB and the cell type information supported by the terminal, that an intersection set exists between a cell type supported by the base station and a cell type supported by the terminal, the paging message is sent to the base station. For example, supported cell types reported by an eNB1 are a type 1 and a type 2, a supported cell type reported by an eNB2 is a type 4, and cell types supported by the UE are the type 1, the type 2, and the type 3. Then, because no intersection set exists between the cell type supported by the eNB2 and the cell types supported by the UE, the first eNB refers only to the eNB1 but not the eNB2, which means, the MME sends the paging message only to the eNB1 and does not send the paging message to the eNB2.

In addition, information that may be carried in the paging message sent to the first eNB is the type 1, the type 2, and the type 3 (that is, the cell type information supported by the UE), or may be the type 1 and the type 2 (that is, the intersection set of the cell type information supported by the first eNB and the cell type information supported by the UE).

45: The first eNB sends a paging message only to a cell corresponding to the information carried in the received paging message.

For example, when the paging message carries the type 1, the type 2, and the type 3 (or carries the type 1 and the type 2), but the first eNB supports only the type 1 and the type 2, the first eNB sends the paging message only to cells corresponding to the type 1 and the type 2. A correspondence between a cell type and a cell identity may be configured during planning.

Optionally, the first message reported by the eNB to the MME further carries a correspondence between cell type information and a cell identity. After determining the cell type information supported by the UE (or the intersection set of the cell type information supported by the first eNB and the cell type information supported by the UE), the MME determines, according to the correspondence, a cell identity corresponding to the cell type information supported by the UE. Later, the MME adds the corresponding cell identity to the paging message sent to the first eNB, and after receiving the paging message, the first eNB sends a paging message only to a cell corresponding to the cell identity.

Optionally, the MME may configure a correspondence between cell type information and a cell identity. Then, by means of processing similar to the foregoing processing, the cell identity is determined according to the correspondence, and the paging message sent to the first eNB carries the cell identity.

In this embodiment, an MME sends a paging message only to an eNB that supports a cell type supported by a UE instead of sending the paging message to all eNBs connected to the MME, which can further reduce a quantity of sent paging messages, and reduce system energy overheads.

FIG. 5 is a schematic flowchart of another embodiment of a paging method according to the present invention, including:

51: Each eNB connected to an MME sends a first message to the MME, where the first message carries cell configuration information of the eNB, and the cell configuration information is a correspondence among a cell identity, a cell type, and activation/sleep switching pattern information of a cell.

In other words, the eNB sends a correspondence among a cell identity of each served cell, a cell type of the cell, and activation and sleep time information of the cell to the MME, so that the MME learns the cell identity, the cell type, and activation and sleep conditions of each cell that is included in each eNB.

The first message may be an existing message, or be a newly added message.

The existing message is, for example, an S1 SETUP REQUEST message or an ENB CONFIGURATION UPDATE message.

After receiving the first message sent by the eNB, the MME may store information about a cell included in the eNB. For example, a cell 1 corresponds to a type 1 and activation/sleep switching pattern information 1, and a cell 2 corresponds to a type 2 and activation/sleep switching pattern information 2.

52: The MME obtains cell type information supported by each UE that is registered with the MME.

53: After receiving a downlink data notification message, the MME obtains cell type information supported by a UE to be paged.

Reference may be made to 31 to 32 for specific content of 52 to 53.

54: The MME determines a first eNB, and sends a paging message to the first eNB, where the paging message carries a cell identity of a first cell.

For example, if an activation/sleep switching type indicates that a cell in an intersection set is currently in an active state, the paging message is sent to a base station.

The first eNB may be determined in a manner used in the previous embodiment, in which the first eNB refers to an eNB, where an intersection set exists between a cell type supported by the eNB and a cell type supported by the UE.

In addition, different from the previous embodiment, the paging message sent by the MME to the first eNB in this embodiment carries the cell identity of the first cell, where the first cell is a cell whose cell type is the same as the cell type supported by the UE and that is currently in the active state. For example, the MME may determine, according to a cell type reported by the eNB, whether this cell type is the same as the cell type supported by the UE, and then may determine, according to activation/sleep switching pattern information of the cell, whether the cell is currently in the active state.

55: The first eNB sends a paging message only to a cell corresponding to the cell identity carried in the received paging message.

For example, the first eNB parses the received paging message to obtain the cell identity, and then sends the paging message only to the cell (that is, the first cell) corresponding to the cell identity.

In this embodiment, an MME sends a paging message only to an eNB that supports a cell type supported by a UE instead of sending the paging message to all eNBs connected to the MME, which can further reduce a quantity of sent paging messages, and reduce system energy overheads. In addition, in this embodiment, the eNB sends a paging message only to a cell that supports the cell type supported by the UE and that is in the active state, which prevents an overhead waste caused by sending the paging message to a sleeping cell, and can further reduce system energy overheads.

In addition, in the foregoing embodiments, to enable the eNB to interact with the MME normally, different representation manners of cell type information may be preconfigured in the eNB and the MME. For example, a is used to represent the type 1, b is used to represent the type 2, and the like. An operation, administration and maintenance (OAM) manner or a fixation manner may be used for this configuration manner. That is, signaling exchange of a third party may be used so that the eNB and the MME learn each representation of cell type information, or each representation of cell type information may be configured by using predetermined code. Furthermore, the OAM configuration manner or the fixation configuration manner may also be used for various correspondences configured in the MME and/or the eNB.

By using any one of the foregoing embodiments, the quantity of sent paging messages can be reduced, and the system energy overheads can be reduced. In addition, an NCT cell may go to sleep, and paging a UE of a cell in a sleep state may increase a delay in a response of the UE to network paging, and may cause a paging failure in a serious case. To solve the problem of the delay in the paging response or the paging failure, the present invention further provides the following embodiments.

FIG. 6 is a schematic flowchart of another embodiment of a paging method according to the present invention, including:

61: An eNB sets a statistical duration T, and collects statistics on paging message arrival conditions of each cell that the eNB serves in this duration.

The paging message arrival conditions may include: a quantity of paging messages that arrive when a cell is in an active state, and a quantity of paging messages that arrive when a cell is in a sleep state.

For example, cells that the eNB serves include a cell 1 and a cell 2, and each cell has its activation/sleep switching pattern information, for example, activated starting from a t1 moment, and an activation duration of t2. Therefore whether each cell is in the sleep state or the active state within a corresponding time segment of the statistical duration T may be learned according to the activation/sleep switching pattern information. In addition, the eNB may further collect statistics on a quantity of paging messages that arrive at the cell in a corresponding time segment. For example, the cell 1 is in the active state within a time segment of t1 to t1+t2 of the statistical duration T. By collecting statistics on a quantity of paging messages that arrive at the cell 1 within the time segment of t1 to t1+t2, a quantity of paging messages that arrive when the cell 1 is in the active state can be determined. A quantity of paging messages that arrive when the cell 1 is in the sleep state, and quantities of paging messages that arrive when the cell 2 is in the active state and the sleep state can also be determined by using a similar method.

62: The eNB determines whether a statistical result of each cell matches current activation/sleep switching pattern information. If the statistical result of each cell does not match the current activation/sleep switching pattern information, perform 63; if the statistical result of each cell matches the current activation/sleep switching pattern information, perform 64.

It may be: For each cell, if the quantity of paging messages that arrive when the cell is in the active state, which is obtained by statistics collection, is a large quantity, and the quantity of paging messages that arrive when the cell is in the sleep state, which is obtained by statistics collection, is a small quantity, it indicates matching; otherwise, it indicates mismatching. A specific large quantity or small quantity may be: Two thresholds are separately set; when the quantity of paging messages that arrive when the cell is in the active state is greater than a first threshold, and the quantity of paging messages that arrive when the cell is in the sleep state is less than a second threshold, it indicates matching, and otherwise, it indicates mismatching. Alternatively, one threshold may also be set; when a difference between the quantity of paging messages that arrive when the cell is in the active state and the quantity of paging messages that arrive when the cell is in the sleep state is greater than the threshold, it indicates matching, and otherwise, it indicates mismatching. Alternatively, one threshold may also be set; when a ratio of the quantity of paging messages that arrive when the cell is in the active state to the quantity of paging messages that arrive when the cell is in the sleep state is greater than the threshold, it indicates matching, and otherwise, it indicates mismatching. Specific matching principles are not limited to what are shown above, and another principle may also be set.

63: The eNB adjusts current activation/sleep switching pattern information of a mismatching cell, so that adjusted activation/sleep switching pattern information matches the statistical result. Later, 61 and its subsequent steps may be repeatedly performed.

For example, activation start time and/or an activation duration of a mismatching cell is changed, so that quantities of paging messages that are obtained by statistics collection separately according to adjusted activation and sleep time segments meet the foregoing matching principles that are set.

64: The eNB retains a current activation/sleep switching pattern. Later, 61 and its subsequent steps may be repeatedly performed.

Optionally, this embodiment may be executed independently, and may also be executed in combination with the foregoing embodiments. For example, the eNB sends a paging message only to a cell corresponding to a type supported by a UE, and the eNB further collects statistics on paging messages of an NCT cell and adjusts activation/sleep switching pattern information of the NCT cell.

In this embodiment, activation/sleep switching pattern information of a cell is adjusted, so that the pattern information can match a paging message arrival model, thereby reducing a paging delay and a paging failure rate.

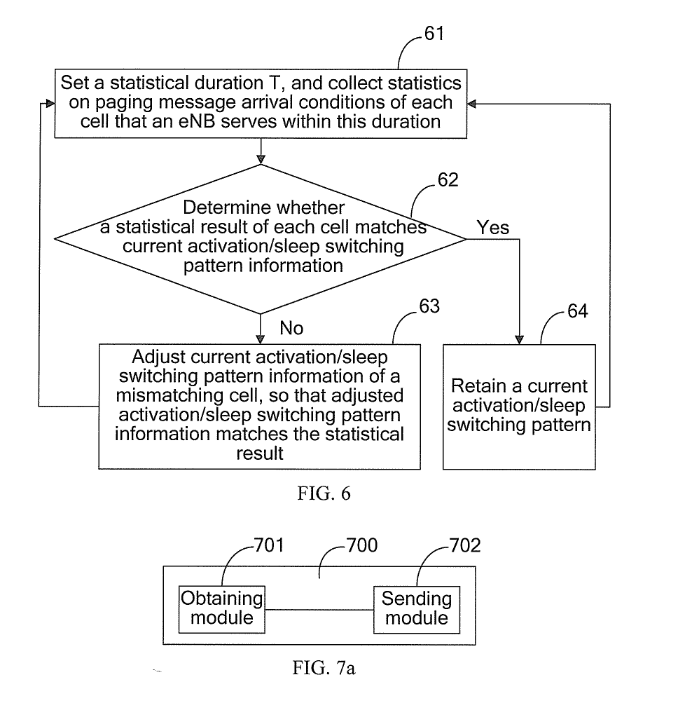

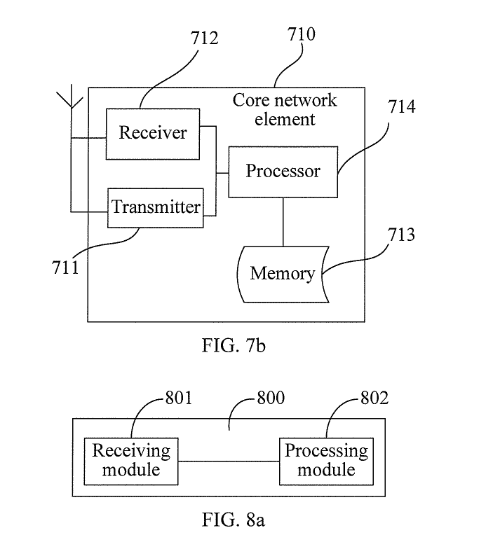

FIG. 7a is a schematic structural diagram of an embodiment of a paging device according to the present invention. The device may be a core network element or be located in a core network element, and the device 700 includes an obtaining module 701 and a sending module 702. The obtaining module 701 is configured to obtain cell type information supported by a terminal; the sending module 702 is configured to send a paging message to a base station, where the paging message carries the cell type information supported by the terminal or a cell identity determined according to the cell type information supported by the terminal, so that the base station sends a paging message to a cell corresponding to the cell type information supported by the terminal or a cell corresponding to the cell identity.

Optionally, the device further includes:

a receiving module, configured to receive cell configuration information of the base station that is sent by the base station, where the cell configuration information of the base station includes cell type information supported by the base station, where
the sending module is specifically configured to send the paging message to the base station when it is determined, according to the cell configuration information of the base station and the cell type information supported by the terminal, that the base station has a first cell, where a type of the first cell is a cell type supported by the terminal.

Optionally, the paging message carries an intersection set of the cell type information supported by the terminal and the cell type information supported by the base station.

Optionally, the device further includes:

a receiving module, configured to receive cell configuration information of the base station that is sent by the base station, where the cell configuration information of the base station includes cell type information supported by the base station, and a cell identity and activation/sleep switching pattern information of each cell of the base station, where

the sending module is specifically configured to send the paging message to the base station when it is determined, according to the cell configuration information of the base station and the cell type information supported by the terminal, that the base station has a first cell in an active state, where a type of the first cell is a cell type supported by the terminal.

Optionally, the paging message sent by the sending module carries a cell identity of the first cell.

Optionally, the cell type information supported by the terminal is the cell type supported by the terminal, and the obtaining module is specifically configured to:

when a downlink data notification message is received, obtain context information of the terminal according to an evolved packet system (EPS) bearer identity or a terminal identifier carried in the downlink data notification message; and

obtain the cell type supported by the terminal from the context information of the terminal.

Optionally, the cell type information supported by the terminal is the cell type supported by the terminal, and the obtaining module is specifically configured to:

when the core network element receives a downlink data notification message, obtain context information of the terminal according to an EPS bearer identity or a terminal identifier carried in the downlink data notification message;

obtain an index of cell type support capability information of the terminal from the context information of the terminal; and

determine, according to the index of cell type support capability information of the terminal and a preconfigured first correspondence, the cell type supported by the terminal, where the first correspondence is a correspondence between the cell type supported by the terminal and the index of cell type support capability information of the terminal.

Optionally, the cell type information supported by the terminal is an index of cell type support capability information of the terminal, and the obtaining module is specifically configured to:

when the core network element receives a downlink data notification message, obtain context information of the terminal according to an EPS bearer identity or a terminal identifier carried in the downlink data notification message; and

obtain the index of cell type support capability information of the terminal from the context information of the terminal.

Optionally, the paging message carries a cell identity determined according to the cell type information supported by the terminal, and the device further includes:

a determining module, configured to determine the cell identity according to the cell type information supported by the terminal and a second correspondence, where the second correspondence is a correspondence between the cell type information supported by the terminal and the cell identity, and the second correspondence is reported by the base station or locally configured in the core network element.

Optionally, the device further includes:

a capability obtaining module, configured to receive capability information reported by the terminal, or obtain capability information of the terminal from a home subscriber server (HSS), where the capability information includes the cell type information supported by the terminal.

In hardware implementation, the foregoing sending module may be a transmitter or a transceiver, the foregoing receiving module may be a receiver or a transceiver, and the sending module and the receiving module may be integrated together to form a transceiving module that corresponds to a transceiver in the hardware implementation. The foregoing obtaining module may be embedded in or independent from a processor of the core network element in a hardware form, and may also be stored in a memory of the core network element in a software form, so that a processor invokes the software to perform operations corresponding to the foregoing modules. The processor maybe a central processing unit (CPU), a microprocessor, a single-chip microcomputer, and the like.

Refer to FIG. 7b that is a schematic structural diagram of a core network element according to an embodiment of the present invention. As shown in the figure, the core network element 710 includes a transmitter 711, a receiver 712, a memory 713, and a processor 714 that is separately connected to the transmitter 711, the receiver 712, and the memory 713. Certainly, the core network element may further include a general part such as an antenna, a baseband processing part, an intermediate radio frequency processing part, and an input/output apparatus, and this embodiment of the present invention does not impose any limit herein again.

A group of program code is stored in the memory, and the processor 714 is configured to invoke the program code stored in the memory to perform the following operations:

obtaining cell type information supported by a terminal, and sending a paging message to a base station by using the transmitter, where the paging message carries the cell type information supported by the terminal or a cell identity determined according to the cell type information supported by the terminal, so that the base station sends a paging message to a cell corresponding to the cell type information supported by the terminal or a cell corresponding to the cell identity.

It should be noted that the devices shown in FIG. 7a and FIG. 7b may be used to implement any method about the core network element that is provided in the foregoing method embodiments, descriptions of the cell type information supported by the terminal, the cell identity determined according to the cell type information supported by the terminal, a method for obtaining the cell type information supported by the terminal, a method for obtaining the cell identity determined according to the cell type information supported by the terminal, and the like are the same as those in the foregoing method embodiments, and details are not described herein again. In this embodiment, a paging message sent by a core network element to a base station carries cell type information supported by a terminal or a cell identity determined according to cell type information supported by a terminal; the base station may determine a corresponding cell according to the cell type information supported by the terminal or the cell identity determined according to the cell type information supported by the terminal, and when sending a paging message, the base station sends the paging message only to the cell corresponding to the cell type information supported by the terminal or the cell corresponding to the cell identity determined according to the cell type information supported by the terminal instead of sending the paging message to all cells included in the base station. This can reduce a quantity of sent paging messages, and reduce system energy overheads.

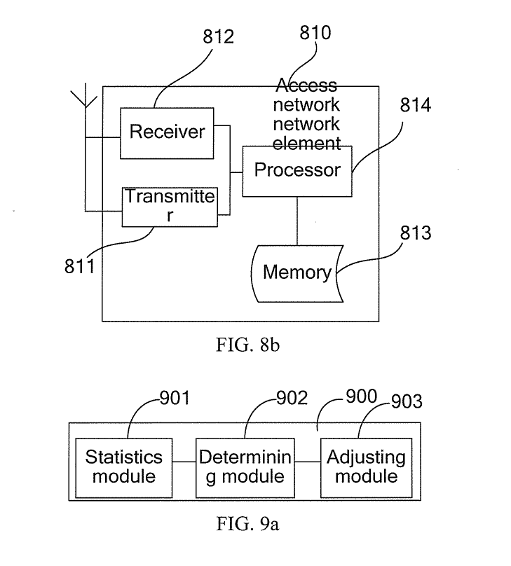

FIG. 8a is a schematic structural diagram of another embodiment of a paging device according to the present invention, where the device may be a base station or be located in a base station, and the device 800 includes a receiving module 801 and a processing module 802. The receiving module 801 is configured to receive a paging message sent by a core network element, where the paging message carries cell type information supported by a terminal or a cell identity determined according to the cell type information supported by a terminal; and the processing module 802 is configured to send a paging message to a cell corresponding to the cell type information supported by the terminal or the cell identity.

Optionally, the device further includes:

a sending module, configured to send cell configuration information of the base station to the core network element, where the cell configuration information of the base station includes cell type information supported by the base station, so that the core network element sends the paging message to the base station when determining, according to the cell configuration information of the base station and the cell type information supported by the terminal, that the base station has a first cell, where a type of the first cell is a cell type supported by the terminal.

Optionally, the device further includes:

a sending module, configured to send cell configuration information of the base station to the core network element, where the cell configuration information of the base station includes cell type information supported by the base station, and a cell identity and activation/sleep switching pattern information of each cell of the base station, so that the core network element sends the paging message to the base station when determining, according to the cell configuration information of the base station and the cell type information supported by the terminal, that the base station has a first cell in an active state, where a type of the first cell is a cell type supported by the terminal.

Optionally, the paging message received by the receiving module carries a cell identity of the first cell.

Optionally, the paging message carries the cell type information supported by the terminal, and the cell type information supported by the terminal is an index of cell type support capability information of the terminal, and the processing module is specifically configured to:

determine, according to the index of cell type support capability information of the terminal and a preconfigured first correspondence, the cell type supported by the terminal, and send a paging message to a cell corresponding to the cell type supported by the terminal, where the first correspondence is a correspondence between the cell type supported by the terminal and the index of cell type support capability information of the terminal. Optionally, the device further includes:

a statistics module, configured to collect statistics on a first quantity and a second quantity within a set duration, where the first quantity is a quantity of paging messages that arrive when an NCT cell is in an active state, and the second quantity is a quantity of paging messages that arrive when the NCT cell is in a sleeping state;

a determining module, configured to determine whether the first quantity and the second quantity match current activation/sleep switching pattern information of the NCT cell; and

an adjusting module, configured to: when the first quantity and the second quantity do not match the current activation/sleep switching pattern information of the NCT cell, adjust the activation/sleep switching pattern information of the NCT cell, so that adjusted activation/sleep switching pattern information matches the first quantity and the second quantity.

In hardware implementation, the foregoing sending module may be a transmitter or a transceiver, the foregoing receiving module may be a receiver or a transceiver, and the sending module and the receiving module may be integrated together to form a transceiving module that corresponds to a transceiver in the hardware implementation. The foregoing processing module may be embedded in or independent from a processor of the base station in a hardware form, and may also be stored in an access network element in a software form, for example, in a memory of the base station, so that a processor invokes the software to perform operations corresponding to the foregoing modules. The processor may be a central processing unit (CPU), a microprocessor, a single-chip microcomputer, and the like.

Refer to FIG. 8b, which is a schematic structural diagram of an access network element according to an embodiment of the present invention. As shown in the figure, the access network element 810 includes a transmitter 811, a receiver 812, a memory 813, and a processor 814 that is separately connected to the transmitter 811, the receiver 812, and the memory 813. Certainly, the access network element may further include a general part such as an antenna, a baseband processing part, an intermediate radio frequency processing part, and an input/output apparatus, and this embodiment of the present invention does not impose any limit herein again.

A group of program code is stored in the memory, and the processor 814 is configured to invoke the program code stored in the memory to perform the following operations:

receiving, by using the receiver, a paging message sent by a core network element, where the paging message carries cell type information supported by a terminal or a cell identity determined according to cell type information supported by a terminal; and sending, by using the transmitter, a paging message to a cell corresponding to the cell type information supported by the terminal or the cell identity.

It should be noted that the devices shown in FIG. 8a and FIG. 8b may be used to implement any method about the access network element that is provided in the foregoing method embodiments, descriptions of the cell type information supported by the terminal, the cell identity determined according to the cell type information supported by the terminal, a method for obtaining the cell type information supported by the terminal, a method for obtaining the cell identity determined according to the cell type information supported by the terminal, and the like are the same as those in the foregoing method embodiments, and details are not described herein again.

In this embodiment, a paging message sent by a core network element to a base station carries cell type information supported by a terminal or a cell identity determined according to cell type information supported by a terminal; the base station sends a paging message to a cell corresponding to the cell type information supported by the terminal or a cell corresponding to the cell identity determined according to the cell type information supported by the terminal instead of sending the paging message to all cells included in the base station. This can reduce a quantity of sent paging messages, and reduce system energy overheads.

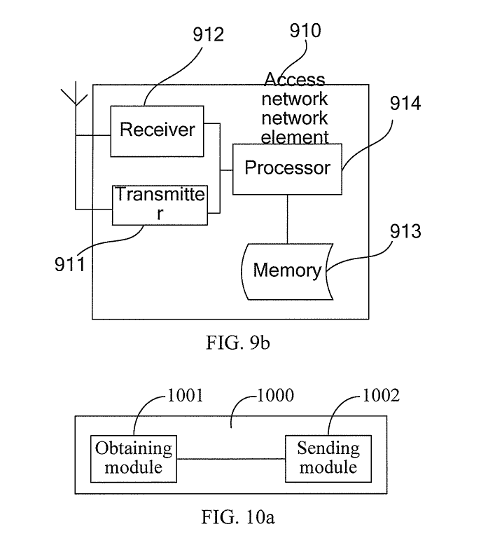

FIG. 9a is a schematic structural diagram of another embodiment of a paging device according to the present invention, where the device 900 includes a statistics module 901, a determining module 902, and an adjusting module 903. The statistics module 901 is configured to collect statistics on a first quantity and a second quantity within a set duration, where the first quantity is a quantity of paging messages that arrive when an NCT cell is in an active state, and the second quantity is a quantity of paging messages that arrive when the NCT cell is in a sleeping state; the determining module 902 is configured to determine whether the first quantity and the second quantity match current activation/sleep switching pattern information of the NCT cell; and the adjusting module 903 is configured to: when the first quantity and the second quantity do not match the current activation/sleep switching pattern information of the NCT cell, adjust the activation/sleep switching pattern information of the NCT cell, so that adjusted activation/sleep switching pattern information matches the first quantity and the second quantity.

In hardware implementation, the foregoing statistics module, determining module, and adjusting module may form a processing module, where the processing module may be embedded in or independent from an access network element in a hardware form, for example, in a processor of a base station, and may also be stored in a memory of the base station in a software form, so that a processor invokes the software to perform operations corresponding to the foregoing modules. The processor may be a central processing unit (CPU), a microprocessor, a single-chip microcomputer, and the like.

Refer to FIG. 9b that is a schematic structural diagram of an access network element according to an embodiment of the present invention. As shown in the figure, the access network element 910 includes a transmitter 911, a receiver 912, a memory 913, and a processor 914 that is separately connected to the transmitter 911, the receiver 912, and the memory 913. Certainly, the access network element may further include a general part such as an antenna, a baseband processing part, an intermediate radio frequency processing part, and an input/output apparatus, and this embodiment of the present invention does not impose any limit herein again.

A group of program code is stored in the memory, and the processor 914 is configured to invoke the program code stored in the memory to perform the following operations:

collecting statistics on a first quantity and a second quantity within a set duration, where the first quantity is a quantity of paging messages that arrive when an NCT cell is in an active state, and the second quantity is a quantity of paging messages that arrive when the NCT cell is in a sleeping state;

determining whether the first quantity and the second quantity match current activation/sleep switching pattern information of the NCT cell; and

when the first quantity and the second quantity do not match the current activation/sleep switching pattern information of the NCT cell, adjusting the activation/sleep switching pattern information of the NCT cell, so that adjusted activation/sleep switching pattern information matches the first quantity and the second quantity.

It should be noted that the devices shown in FIG. 9a and FIG. 9b may be used to implement any method about the access network element that is provided in the foregoing method embodiments, descriptions of a method for obtaining the first quantity, a method for obtaining the second quantity, whether the first quantity and the second quantity match the current activation/sleep switching pattern information of the NCT cell, and the like are the same as those in the foregoing method embodiments, and details are not described herein again.

In this embodiment, activation/sleep switching pattern information of a cell is adjusted, so that this pattern information can match a paging message arrival model, thereby reducing a paging delay and a paging failure rate.

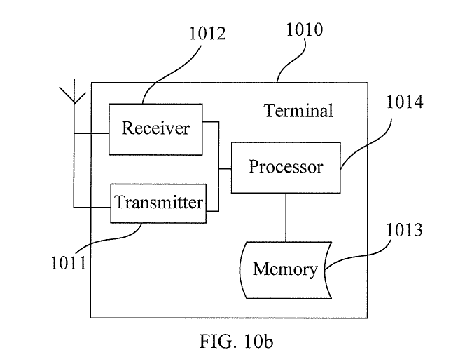

FIG. 10a is a schematic structural diagram of another embodiment of a paging device according to the present invention, where the device 1000 may be a terminal or be located in a terminal, and the device 1000 includes an obtaining module 1001 and a sending module 1002. The obtaining module 1001 is configured to obtain cell type support capability information of the device 1000; and the sending module 1002 is configured to send the cell type support capability information of the terminal to a core network element, so that the core network element obtains and stores, according to the cell type support capability information of the terminal, cell type information supported by the terminal, and when the core network element sends a paging message to a base station, the paging message carries the cell type information supported by the terminal or a cell identity determined according to the cell type information supported by the terminal.

In hardware implementation, the foregoing sending module may be a transmitter or a transceiver, and the foregoing obtaining module may be embedded in or independent from a processor of the terminal in a hardware form, and may also be stored in the terminal in a software form, for example, in a memory of the terminal, so that a processor invokes the software to perform operations corresponding to the foregoing modules. The processor may be a central processing unit (CPU) , a microprocessor, a single-chip microcomputer, and the like.

Refer to FIG. 10b that is a schematic structural diagram of a terminal according to an embodiment of the present invention. As shown in the figure, the terminal 1010 includes a transmitter 1011, a receiver 1012, a memory 1013, and a processor 1014 that is separately connected to the transmitter 1011, the receiver 1012, and the memory 1013. Certainly, the terminal may further include a general part such as an antenna, a baseband processing part, an intermediate radio frequency processing part, and an input/output apparatus, and this embodiment of the present invention does not impose any limit herein again.

A group of program code is stored in the memory, and the processor 1014 is configured to invoke the program code stored in the memory to perform the following operations:

obtaining cell type support capability information of the terminal 1010; and

sending, by using the transmitter, the cell type support capability information of the terminal to a core network element, so that the core network element obtains and stores, according to the cell type support capability information of the terminal, cell type information supported by the terminal, and when the core network element sends a paging message to a base station, the paging message carries the cell type information supported by the terminal or a cell identity determined according to the cell type information supported by the terminal.

It should be noted that the devices shown in FIG. 10a and FIG. 10b may be used to implement any method about the terminal that is provided in the foregoing method embodiments, descriptions of the cell type support capability information, a sending manner of sending the cell type support capability information to the core network element, and the like are the same as those in the foregoing method embodiments, and details are not described herein again.

In this embodiment, a terminal sends cell type support capability information to a core network element, so that the core network element can obtain and store, according to the cell type support capability information of the terminal, cell type information supported by the terminal, and when the core network element sends a paging message to a base station, the paging message carries the cell type information supported by the terminal or a cell identity determined according to the cell type information supported by the terminal, so that the base station sends a paging message to a cell corresponding to the cell type information supported by the terminal or a cell corresponding to the cell identity determined according to the cell type information supported by the terminal instead of sending the paging message to all cells included in the base station. This can reduce a quantity of sent paging messages, and reduce system energy overheads.

It may be clearly understood by persons skilled in the art that, for the purpose of convenient and brief description, division of the foregoing functional modules is taken as an example for illustration. In actual application, the foregoing functions can be allocated to different functional modules and implemented according to a requirement, that is, an inner structure of an apparatus is divided into different functional modules to implement all or some of the functions described above. For a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present application essentially, or the part contributing to the prior art, or all or some of the technical solutions may be implemented in the form of a software product. The software product is stored in a storage medium and includes several instructions for instructing a computer device (which may be a personal computer, a server, or a network device) or a processor to perform all or some of the steps of the methods described in the embodiments of the present application. The foregoing storage medium includes: any medium that can store program code, such as a USB flash drive, a removable hard disk, a read-only memory (ROM), a random access memory (RAM), a magnetic disk, or an optical disc.

The foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present application.

What is claimed is:

1. A paging method, comprising:
receiving, by a base station, a first paging message sent by a core network element, wherein the first paging message carries cell type information supported by a terminal or a cell identity determined according to cell type information supported by a terminal; and
sending, by the base station, a second paging message in a cell corresponding to the cell type information supported by the terminal or the cell identity.

2. The method according to claim 1, further comprising:
sending, by the base station, cell configuration information of the base station to the core network element, wherein the cell configuration information of the base station comprises cell type information supported by the base station, so that the core network element sends the first paging message to the base station when determining, according to the cell configuration information of the base station and the cell type information supported by the terminal, that the base station has a first cell, wherein a type of the first cell is a cell type supported by the terminal.

3. The method according to claim 1, further comprising:
sending, by the base station, cell configuration information of the base station to the core network element, wherein the cell configuration information of the base station comprises cell type information supported by the base station, and a cell identity and activation/sleep switching pattern information of each cell of the base station, so that the core network element sends the first paging message to the base station when determining, according to the cell configuration information of the base station and the cell type information supported by the terminal, that the base station has a first cell in an active state, wherein a type of the first cell is a cell type supported by the terminal.

4. The method according to claim 3, wherein the first paging message carries a cell identity of the first cell.

5. The method according to claim 1, wherein:
the first paging message carries the cell type information supported by the terminal, the cell type information supported by the terminal is an index of cell type support capability information of the terminal; and
sending, by the base station, a second paging message in a cell corresponding to the cell type information supported by the terminal comprises:
determining, according to the index of cell type support capability information of the terminal and a preconfigured first correspondence, the cell type supported by the terminal, and sending the second paging message in a cell corresponding to the cell type supported by the terminal, wherein the first correspondence is a correspondence between the cell type supported by the terminal and the index of cell type support capability information of the terminal.

6. The method according to claim 1, further comprising:
collecting, by the base station, statistics on a first quantity and a second quantity within a set duration, wherein the first quantity is a quantity of paging messages that arrive when a new carrier type (NCT) cell is in an active state, and the second quantity is a quantity of paging messages that arrive when the NCT cell is in a sleep state;
determining, by the base station, whether the first quantity and the second quantity match current activation/sleep switching pattern information of the NCT cell; and
when the first quantity and the second quantity do not match the current activation/sleep switching pattern information of the NCT cell, adjusting, by the base station, the activation/sleep switching pattern information of the NCT cell, so that adjusted activation/sleep switching pattern information matches the first quantity and the second quantity.

7. A paging device, applied to a core network element, the paging device comprising:
a processor and a non-transitory computer readable storage medium coupled to the processor, wherein the non-transitory computer readable storage medium comprises a program which when executed by the processor causes the processor to:
obtain cell type information supported by a terminal; and
send a first paging message to abase station, wherein the first paging message carries the cell type information supported by the terminal or a cell identity determined according to the cell type information supported by the terminal, so that the base station sends a second paging message in a cell corresponding to the cell type information supported by the terminal or a cell corresponding to the cell identity.

8. The device according to claim 7, wherein the program further causes the processor to:
receive cell configuration information of the base station that is sent by the base station, wherein the cell configuration information of the base station comprises cell type information supported by the base station;
determine, according to the cell configuration information of the base station and the cell type information supported by the terminal, whether the base station has a first cell, wherein a type of the first cell is a cell type supported by the terminal, wherein,
the first paging message is sent to the base station when the base station has the first cell.

9. The device according to claim 8, wherein the paging message carries an intersection set of the cell type information supported by the terminal and the cell type information supported by the base station.

10. The device according to claim 7, wherein the program further causes the processor to:
receive cell configuration information of the base station that is sent by the base station, wherein the cell configuration information of the base station comprises cell type information supported by the base station, and a cell identity and activation/sleep switching pattern information of each cell of the base station;
determine, according to the cell configuration information of the base station and the cell type information supported by the terminal, whether the base station has a first cell in an active state, wherein a type of the first cell is a cell type supported by the terminal, wherein,
the first paging message is sent to the base station when the base station has the first cell.

11. The device according to claim 10, wherein the first paging message carries a cell identity of the first cell.

12. The device according to claim 7, wherein:
the cell type information supported by the terminal is the cell type supported by the terminal or an index of cell type support capability information of the terminal; and
the program further causes the processor to:
when a downlink data notification message is received, obtain context information of the terminal according to an evolved packet system (EPS) bearer identity or a terminal identifier carried in the downlink data notification message, and
obtain the cell type information supported by the terminal from the context information of the terminal.

13. The device according to claim 7, wherein:
the cell type information supported by the terminal is the cell type supported by the terminal; and
the program further causes the processor to:
when a downlink data notification message is received, obtain context information of the terminal according to an EPS bearer identity or a terminal identifier carried in the downlink data notification message,
obtain an index of cell type support capability information of the terminal from the context information of the terminal, and
determine, according to the index of cell type support capability information of the terminal and a preconfigured first correspondence, the cell type supported by the terminal, wherein the first correspondence is a correspondence between the cell type supported by the terminal and the index of cell type support capability information of the terminal.

14. The device according to claim 7, wherein:
the first paging message carries the cell identity determined according to the cell type information supported by the terminal; and
the program further causes the processor to:
determine the cell identity according to the cell type information supported by the terminal and a second correspondence, wherein the second correspondence is a correspondence between the cell type information supported by the terminal and the cell identity, and the second correspondence is reported by the base station or locally configured in the paging device.

15. The device according to claim 7, the program further causes the processor to:
receive capability information reported by the terminal, or obtain capability information of the terminal from a home subscriber server (HSS), wherein the capability information comprises the cell type information supported by the terminal.

16. A paging device, applied to a base station, the paging device comprising:
a processor and a non-transitory computer readable storage medium coupled to the processor, wherein the non-transitory computer readable storage medium comprises a program which when executed causes the processor to:
receive a first paging message sent by a core network element, wherein the first paging message carries cell type information supported by a terminal or a cell identity determined according to cell type information supported by a terminal; and
send a second paging message in a cell corresponding to the cell type information supported by the terminal or the cell identity.

17. The device according to claim 16, wherein the program further causes the processor to:
send cell configuration information of the base station to the core network element, wherein the cell configuration information of the base station comprises cell type information supported by the base station, so that the core network element sends the first paging message to the base station when determining, according to the cell configuration information of the base station and the cell type information supported by the terminal, that the base station has a first cell, wherein a type of the first cell is a cell type supported by the terminal.

18. The device according to claim 16, wherein the program further causes the processor to:
send cell configuration information of the base station to the core network element, wherein the cell configuration information of the base station comprises cell type information supported by the base station, and a cell identity and activation/sleep switching pattern information of each cell of the base station, so that the core network element sends the first paging message to the base station when determining, according to the cell configuration information of the base station and the cell type information supported by the terminal, that the base station has a first cell in an active state, wherein a type of the first cell is a cell type supported by the terminal.

19. The device according to claim 18, wherein the first paging message carries a cell identity of the first cell.

20. The device according to claim 16, wherein:
the first paging message carries the cell type information supported by the terminal, the cell type information supported by the terminal is an index of cell type support capability information of the terminal; and
the program further causes the processor to:
determine, according to the index of cell type support capability information of the terminal and a preconfigured first correspondence, the cell type supported by the terminal, wherein the first correspondence is a correspondence between the cell type supported by the terminal and the index of cell type support capability information of the terminal, and
send the second paging message in a cell corresponding to the cell type supported by the terminal.

21. The device according to claim 16, wherein the program further causes the processor to:
collect statistics on a first quantity and a second quantity within a set duration, wherein the first quantity is a quantity of paging messages that arrive when a new carrier type (NCT) cell is in an active state, and the second quantity is a quantity of paging messages that arrive when the NCT cell is in a sleep state;
determine whether the first quantity and the second quantity match current activation/sleep switching pattern information of the NCT cell; and
when the first quantity and the second quantity do not match the current activation/sleep switching pattern information of the NCT cell, adjust the activation/sleep switching pattern information of the NCT cell, so that adjusted activation/sleep switching pattern information matches the first quantity and the second quantity.

22. A paging device, applied in a terminal, the paging device comprising:
a processor and a non-transitory computer readable storage medium coupled to the processor, wherein the non-transitory computer readable storage medium comprises a program which when executed causes the processor to:
obtain cell type support capability information of the terminal; and
send the cell type support capability information of the terminal to a core network element, so that the core network element obtains and stores, according to the cell type support capability information of the terminal, cell type information supported by the terminal, and when the core network element sends a paging message to abase station, the paging message carries the cell type information supported by the terminal or a cell identity determined according to the cell type information supported by the terminal.
